(19) United States
(12) Patent Application Publication
(10) Pub. No.: US 2025/0390922 A1
(43) Pub. Date: Dec. 25, 2025

(54) SHOPPING TERMINAL, METHOD, AND SHOPPING SYSTEM

(71) Applicant: Toshiba Tec Kabushiki Kaisha, Tokyo (JP)

(72) Inventor: Hiroshi IWASAKI, Susono Shizuoka (JP)

(21) Appl. No.: 19/057,904

(22) Filed: Feb. 19, 2025

(30) Foreign Application Priority Data
Jun. 25, 2024 (JP) 2024-101627

(51) Int. Cl. G06Q 30/0601

(52) U.S. Cl. CPC G06Q 30/0617

(57) ABSTRACT

A shopping terminal that is used in a store includes a memory that stores labels indicating environmental conditions each in association with sensor data, and a processor configured to execute a program that is stored in the memory to perform the steps of: acquiring a query indicating a question input by a user, acquiring sensor data from a sensor, searching the memory for a label corresponding to the acquired sensor data, generating a prompt based on the query and the label, inputting the prompt to a computer model, which generates in response thereto an answer to the question, the computer model having learned relationships and connections between human perceptions under different environmental conditions, and data of items sold in the store, and converting the answer into audio data, and outputting the audio data.

### CROSS-REFERENCE TO RELATED APPLICATION

This application is based upon and claims the benefit of priority from Japanese Patent Application No. 2024-101627, filed Jun. 25, 2024, the entire contents of which are incorporated herein by reference.

### FIELD

Embodiments described herein relate generally to a shopping terminal, a method, and a shopping system.

### BACKGROUND

In recent years, a natural language processing system, which uses a generative artificial intelligence (AI), such as a Large Language Model (LLM), capable of generating natural sentences, has emerged. Also, to improve the accuracy of an answer generated by a generative AI, a technique called Retrieval Augmented Generation (RAG) is used. In RAG, supplementary information is acquired from, for example, queries input to the generative AI in the past, and the supplementary information is added to a query to be input to the generative AI.

A user who uses a generative AI enters queries under various environments and conditions. Therefore, for example, answers desired by the user may vary depending on environmental changes, such as temperature changes.

However, in the related art, although supplementary information can be added to a query, the supplementary information is limited to, for example, past queries themselves, time zones when the queries are input, and the frequencies at which the queries are input. Therefore, in the related art, it is not possible to reflect the environments and conditions surrounding a user of a generative AI in answers generated by the generative AI, and there is a room for improvement in the accuracy of answers generated by the generative AI.

### SUMMARY OF THE INVENTION

Embodiments of the present invention provide a shopping terminal, a method, and a shopping system capable of reflecting, in answers of a generative AI, information on environments and conditions surrounding a user of the generative AI.

An aspect of the present disclosure provides a shopping terminal that is used in a store, comprising a memory that stores labels indicating environmental conditions each in association with sensor data; and a processor configured to execute a program that is stored in the memory to perform the steps of: acquiring a query indicating a question input by a user, acquiring sensor data from a sensor, searching the memory for a label corresponding to the acquired sensor data, generating a prompt based on the query and the label, inputting the prompt to a computer model, which generates in response thereto an answer to the question, wherein the computer model has learned relationships and connections between human perceptions under different environmental conditions, and data of items sold in the store, and converting the answer into audio data, and outputting the audio data.

### BRIEF DESCRIPTION OF THE DRAWINGS

FIG. 1 is a diagram illustrating a schematic configuration of a concierge system according to an embodiment.

FIG. 2 is a block diagram illustrating a hardware configuration of an interface device according to the embodiment.

FIG. 3 is a block diagram illustrating a hardware configuration of a text generation device according to the embodiment.

FIG. 4 is a table showing a data structure of a label dictionary according to the embodiment.

FIG. 5 is a table showing a structure of a question record DB stored in the text generation device according to the embodiment.

FIG. 6 is a block diagram illustrating functional configurations of the interface device and the text generation device according to the embodiment.

FIG. 7 is a sequence diagram illustrating an example of a control process performed by the concierge system.

### DETAILED DESCRIPTION

Hereinafter, embodiments of the present disclosure will be described with reference to the drawings. The present disclosure is not limited to the embodiments described below.

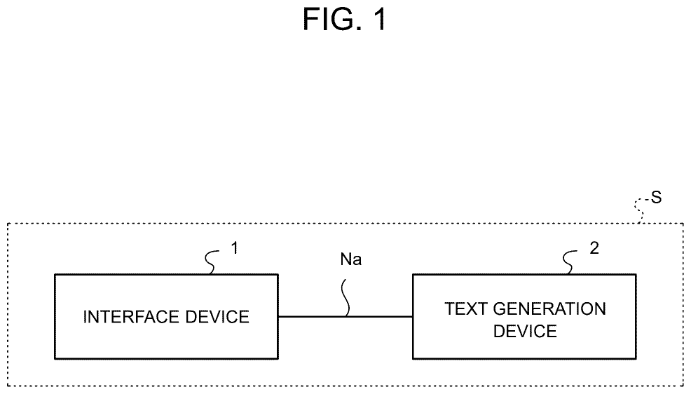

FIG. 1 is a diagram illustrating a schematic configuration of a concierge system S according to an embodiment. As illustrated in FIG. 1, the concierge system S includes an interface device 1 and a text generation device 2. For example, the concierge system S is provided in a store, such as a supermarket or a department store, and provides a customer with information, such as the location of a product and a recommended product. The interface device 1 and the text generation device 2 are connected for communication to each other by wire or wirelessly. In one embodiment, the concierge system S can be a shopping terminal or kiosk into which the interface device 1 and the text generating device 2 are integrated.

The interface device 1 is, for example, a communication robot installed in a store. The interface device 1 is an example of a first information processing device. The interface device 1 exchanges various kinds of information with a user of the concierge system S. The user in the present embodiment is, for example, a customer of a store.

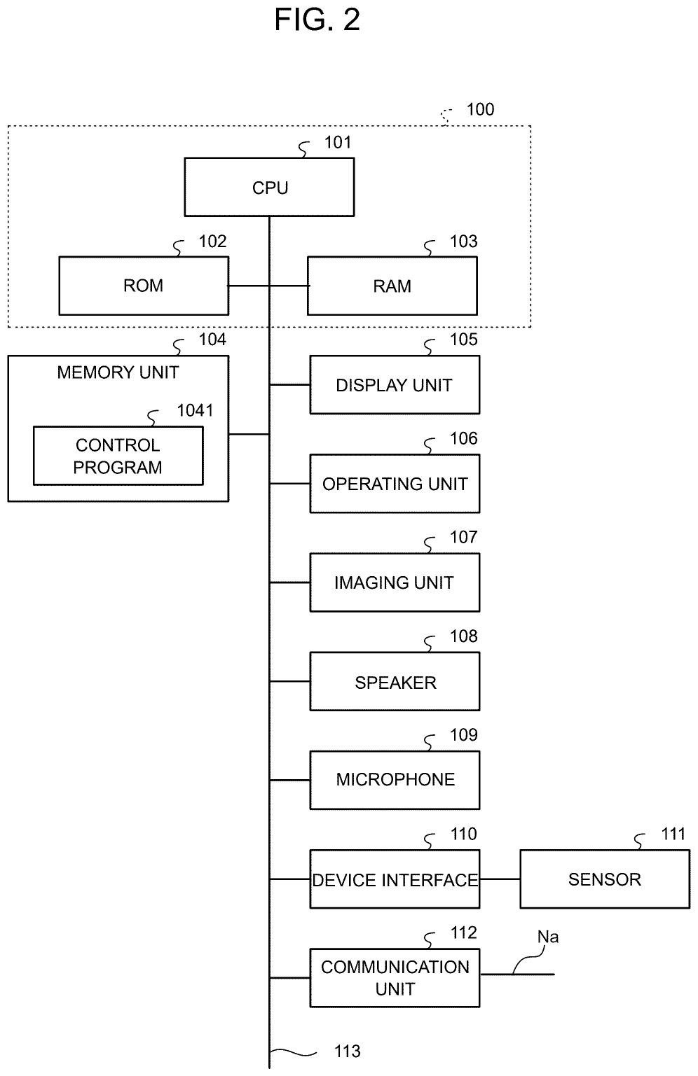

Specifically, when detecting a user of the concierge system S, the interface device 1 acquires sensor data related to the environment around the user or the store by using a sensor 111 (see FIG. 2). In addition, when receiving an input of audio data from the user via a microphone 109 (see FIG. 2), the interface device 1 transmits the sensor data and the audio data to the text generation device 2. Also, when audio data is received from the text generation device 2, the interface device 1 outputs the received audio data via a speaker 108 (see FIG. 2).

In the present embodiment, the interface device 1 is a communication robot. However, the present disclosure is not limited to this example. As another example, the interface device 1 may be a mobile terminal rented from a store to a customer, a tablet terminal mounted on a cart, a mobile terminal, such as a smartphone, carried by a user, or the like.

The text generation device 2 is an example of an information processing device according to the present embodiment and may also be referred to as a second information processing device. The text generation device 2 converts audio data transmitted from the interface device 1 into text data to generate a query. Also, the text generation device 2 converts sensor data transmitted from the interface device 1 into a label described later. Furthermore, the text generation device 2 generates an answer based on the query and the label and outputs the generated answer. The answer is text including a response to a query. Specifically, the text generation device 2 generates an answer in consideration of environmental information related to the environment around the user (or the store) based on various types of sensor data acquired by the sensor 111.

In the present embodiment, it is assumed that the text generation device 2 is implemented by a single device. However, the text generation device 2 may be implemented by multiple devices. Also, the interface device 1 and the text generation device 2 may be integrated into a single device.

Next, a hardware configuration of the interface device 1 will be described. FIG. 2 is a block diagram illustrating an example of a hardware configuration of the interface device 1.

As illustrated in FIG. 2, the interface device 1 includes a CPU (Central Processing Unit) 101, a ROM (Read-Only Memory) 102, a RAM (Random Access Memory) 103, a memory unit 104, a display unit 105, an operating unit 106, an imaging unit 107, a speaker 108, a microphone 109, a device interface 110, a sensor 111, and a communication unit 112.

The CPU 101 is an example of a processor and controls other components of the interface device 1. The ROM 102 stores various programs. The RAM 103 is a workspace into which programs and various types of data are loaded.

The memory unit 104 is a non-volatile memory, such as an HDD (Hard Disk Drive) or a flash memory, that retains stored data even when the power is turned off. The memory unit 104 stores a control program 1041.

The control program 1041 is for controlling the interface device 1. The CPU 101, the ROM 102, the RAM 103, and the memory unit 104 are connected to each other via a bus 113. The CPU 101, the ROM 102, and the RAM 103 constitute a control unit 100 with a computer configuration. In the control unit 100, the CPU 101 executes the control program 1041, which is stored in the ROM 102 or the memory unit 104 and loaded into the RAM 103, and thereby performs a control process of the interface device 1, which will be described later.

The control unit 100 is connected to the display unit 105, the operating unit 106, the imaging unit 107, the speaker 108, the microphone 109, the device interface 110, and the communication unit 112 via the bus 113.

The display unit 105 is a display device, such as an LCD (Liquid Crystal Display). The display unit 105 displays various types of data under the control of the CPU 101.

The operating unit 106 receives various inputs from the user. The operating unit 106 is, for example, a touch panel mounted on the display surface of the display unit 105. The operating unit 106 may also be an input device, such as a keyboard or a pointing device.

The imaging unit 107 is an imaging device including an image sensor, such as a CCD (Charge Coupled Device) or a CMOS (Complementary Metal Oxide Semiconductor) sensor. The imaging unit 107 captures an image of a user by detecting the user who operates the interface device 1.

The speaker 108 is an example of an audio output device. The speaker 108 outputs audio based on audio data input from the CPU 101.

The microphone 109 is an example of an audio input device. The microphone 109 converts voice of the user into audio data and outputs the audio data to the CPU 101.

The device interface 110 acquires sensor data from the sensor 111. Assuming that the sensor 111 outputs an analog value, the device interface 110 includes a signal processing circuit and an analog-to-digital (A/D) converter. Assuming that the sensor 111 has a communication function and transmits a measurement value to the interface device 1 as digital data, the device interface 110 includes a communication interface for wired or wireless communication with the sensor 111. The sensor data acquired by the device interface 110 is transmitted to the control unit 100.

The sensor 111 senses the surrounding environment. Here, the surrounding environment in the present embodiment is an environment surrounding a user who receives an answer. However, the surrounding environment of a user does not only indicate the environment in the immediate vicinity of the user but may also indicate the environment in the neighborhood of the user or a store where the user is currently visiting (that is, a store in which the concierge system S is provided). For example, the surrounding environment may indicate the temperature, humidity, wind speed, and/or weather in an area including a store in which the concierge system S is provided. The surrounding environment may further include other elements.

In the present embodiment, the sensor 111 is installed, for example, at the entrance of a store or on a sales floor and measures data related to the environment around the position where the sensor 111 is installed. The sensor 111 may include, for example, one or more of a temperature sensor, a humidity sensor, an atmospheric pressure sensor, an illuminance sensor, a human presence sensor, and an ultrasonic sensor. Note that the sensor 111 may also be any other type of sensor. The sensor 111 transmits one or more measurement results as sensor data to the device interface 110. The sensor data is, for example, numerical data indicating measurement results, such as a temperature and humidity, of the sensor 111. The sensor data output from the sensor 111 may be either analog data or digital data. Hereinafter, sensor data related to the surrounding environment measured by the sensor 111 is also referred to as “environmental information”.

Note that the sensor 111 may also be installed outside of a store to measure data related to the environment around the store in which the concierge system S is provided.

The communication unit 112 is a communication interface, such as a LAN I/F (Interface), and is connected to a network Na. For example, the communication unit 112 transmits and receives various types of data to and from the text generation device 2 via the network Na. The communication unit 112 can also be connected to a network, such as the Internet, or to another information processing device under the control of the control unit 100. When the sensor 111 has a communication function, the communication unit 112 may also serve as the device interface 110.

The communication unit 112 may also acquire, from a server (not shown) via a network such as the Internet, environmental information indicating the environment around a store in which the concierge system S is provided. For example, the communication unit 112 may acquire data, such as a temperature, humidity, and a precipitation probability in a surrounding area of a store in which the concierge system S is provided, from a server that manages data related to weather forecasts.

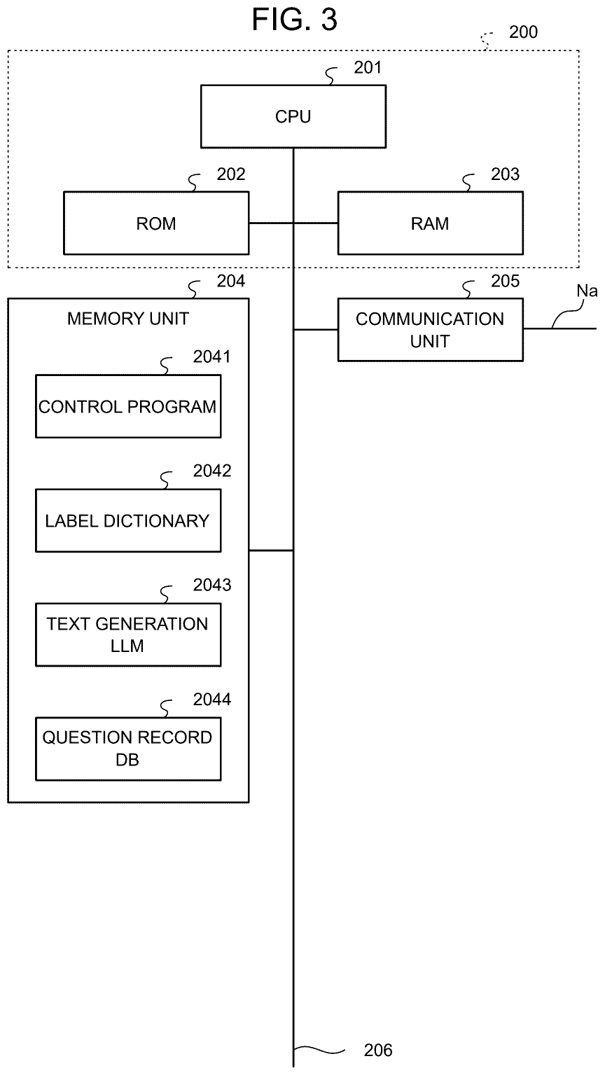

Next, a hardware configuration of the text generation device 2 will be described. FIG. 3 is a block diagram illustrating an example of a hardware configuration of the text generation device 2.

As illustrated in FIG. 3, the text generation device 2 includes a CPU 201, which is an example of a processor, a ROM 202, a RAM 203, a memory unit 204, and a communication unit 205.

The CPU 201 controls other components of the text generation device 2. The ROM 202 stores various programs. The RAM 203 is a workspace into which programs and various types of data are loaded.

The memory unit 204 is an example of a memory. For example, the memory unit 204 is a non-volatile memory, such as an HDD or a flash memory, that retains stored data even when the power is turned off. The memory unit 204 stores a control program 2041, a label dictionary 2042, a text generation LLM 2043, and a question record DB 2044.

The control program 2041 is for controlling the text generation device 2. The CPU 201, the ROM 202, the RAM 203, and the memory unit 204 are connected to each other via a bus 206. The CPU 201, the ROM 202, and the RAM 203 constitute a control unit 200 with a computer configuration. In the control unit 200, the CPU 201 executes the control program 2041 stored in the ROM 202 or the memory unit 204 and loaded into the RAM 203 and thereby performs a control process of the text generation device 2, which will be described later.

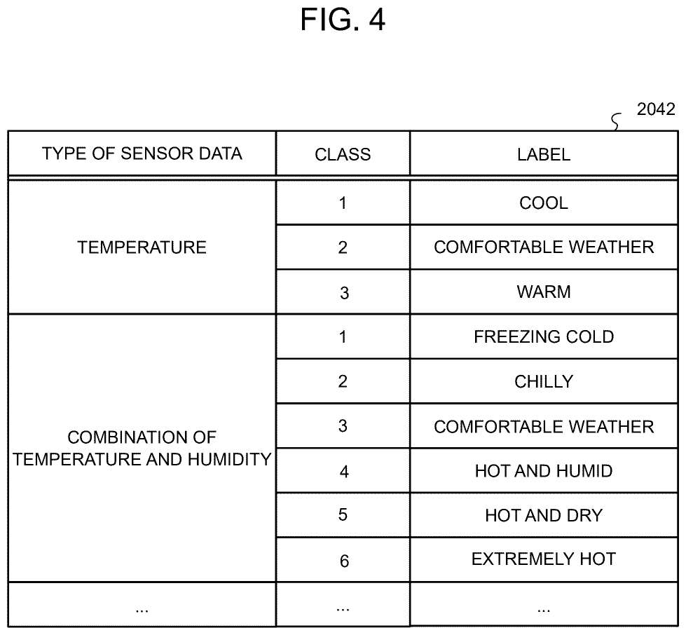

The label dictionary 2042 stores labels in association with the classes of each type of sensor data. FIG. 4 is a table showing an example of a data structure of the label dictionary 2042. As shown in FIG. 4, the label dictionary 2042 stores types of sensor data, classes, and labels in association with each other.

Each type of sensor data may correspond to a measurement from one sensor included in the sensor 111 or may correspond to a combination of measurements from multiple sensors included in the sensor 111. In the example shown in FIG. 4, the label dictionary 2042 stores two types of sensor data, i.e., a temperature measured by a temperature sensor and a combination of a temperature measured by a temperature sensor and humidity measured by a humidity sensor. Note that the types of sensor data are not limited to those shown in FIG. 4.

The classes classify sensor data according to the values of the sensor data. Here, the classification of sensor data means that input sensor data is associated with one of multiple classes defined for each type of sensor data. For example, values of sensor data may be classified using one or more thresholds or using a trained model in machine learning

For each type of sensor data, the classes are associated with different labels. Each label is text that qualitatively expresses a state indicated by sensor data. In the example illustrated in FIG. 4, temperatures measured by the temperature sensor are classified into classes 1 to 3, and labels “cool”, “comfortable weather”, and “warm” are associated with classes 1 to 3, respectively. Also, combinations of the temperature measured by the temperature sensor and the humidity measured by the humidity sensor are classified into classes 1 to 6, and labels “freezing cold”, “chilly”, “comfortable weather”, “hot and humid”, “hot and dry”, and “extremely hot” are associated with classes 1 to 6, respectively. In other words, each label expresses environmental information corresponding to the value of sensor data that falls in one of the classes.

Because each label is provided for the purpose of converting numerical data into text, the label itself does not include a numerical value.

In FIG. 4, each class is associated with one label. However, multiple labels may be associated with each class. Also, although labels for different types of sensor data are registered in one table in FIG. 4, the label dictionary 2042 may be constituted by multiple tables each of which stores labels for one type of sensor data.

Returning to FIG. 3, the text generation LLM 2043 is a generative AI that generates text and is, for example, a Large Language Model (LLM). The text generation LLM 2043 is an example of a computer model. The text generation LLM 2043 receives an input of a prompt including a query and generates an answer corresponding to the query. Although LLM is used as a generative AI in the present embodiment, any other type of text generation AI may also be used.

The text generation LLM 2043 is constructed by a well-known deep learning technique or the like and has a function to output an answer in response to a prompt describing a condition, such as a question. Here, for example, the condition is a request for the guidance on the location of a product or a recommendation of a product.

The text generation LLM 2043 of the present embodiment generates text based on a label representing environmental information and a query from the user, that is, generates an answer reflecting environmental information in response to an input of a prompt.

Note that fine-tuning specialized for a store using the concierge system S may be performed on the text generation LLM 2043. The fine tuning may change the content of an answer to an input prompt or may change the wording of text to be output. In other words, the text generation LLM 2043 may be fine-tuned to change an answer or the wording of the answer according to the application of the text generation device 2. For example, the text generation LLM 2043 used in the present embodiment may be trained with particular expressions, such as the tone or the sentence endings of a character of a store using the concierge system S.

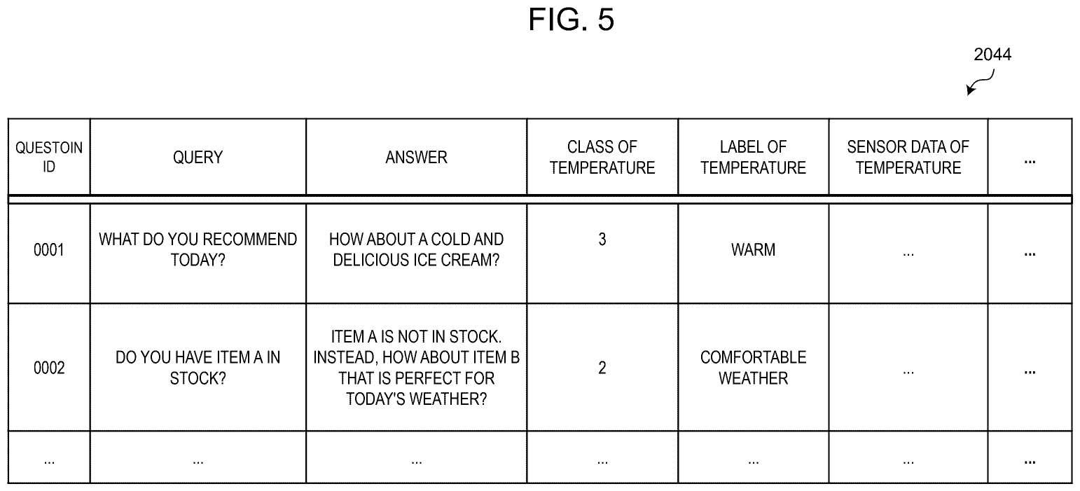

The question record DB 2044 is a database that manages records related to exchanges between the user and the interface device 1. FIG. 5 is a table showing an example of a data structure of the question record DB 2044 stored in the text generation device 2. As shown in FIG. 5, each record in the question record DB 2044 stores a question ID, a query, an answer to the query, a class of sensor data related to the query, a label corresponding to the class, and a value of the sensor data in association with each other. Hereinafter, the above-described data set stored in the question record DB 2044 is also referred to as question record data.

The question ID is identification information that can uniquely identify a query that is based on audio data input by the user to the interface device 1.

The query is text obtained by converting audio data that includes a question and is input by the user to the interface device 1. For example, in the example shown in FIG. 5, a question ID “0001” is associated with a query “What do you recommend today?”, and a question ID “0002” is associated with a query “Do you have item A in stock?”

The answer is text generated by the text generation LLM 2043 in response to a prompt. For example, in the example shown in FIG. 5, the question ID “0001” is associated with an answer “How about a cold and delicious ice cream?”, and the question ID “0002” is associated with an answer “Item A is not in stock. Instead, how about item B that is perfect for today's weather?”

The classes of sensor data and the labels corresponding to the classes in the question record DB 2044 correspond to the classes and labels in the label dictionary 2042 shown in FIG. 4. In FIG. 5, classes of temperatures are shown as examples of classes of sensor data, and labels for temperatures are shown as examples of labels corresponding to the classes. For example, in FIG. 5, a class “3” and a label “warm” are associated with the question ID “0001”, and a class “2” and a label “comfortable weather” are associated with the question ID “0002”.

Here, the label and the class stored in each record of the question record DB 2044 correspond to the label and the class used to generate a prompt input to the text generation LLM 2043.

Sensor data is represented by a numerical value measured by the sensor 111. In FIG. 5, temperature sensor data is shown as an example of sensor data.

Note that the data stored in the question record DB 2044 is not limited to the above-described example. The question record DB 2044 may also include daily or monthly sales history of items appearing in the queries or the answers. For example, storing the sales history of items appearing in the queries or the answers makes it possible to analyze whether the sales of items recommended to the user using the concierge system S have changed.

Returning to FIG. 3, the control unit 200 is connected to the communication unit 205 via the bus 206. The communication unit 205 is a communication interface, such as a LAN I/F, and is connected to the network Na. The communication unit 205 transmits and receives various types of data to and from, for example, the interface device 1 via the network Na. The communication unit 205 may also be connected to a network, such as the Internet, or another information processing device under the control of the control unit 200.

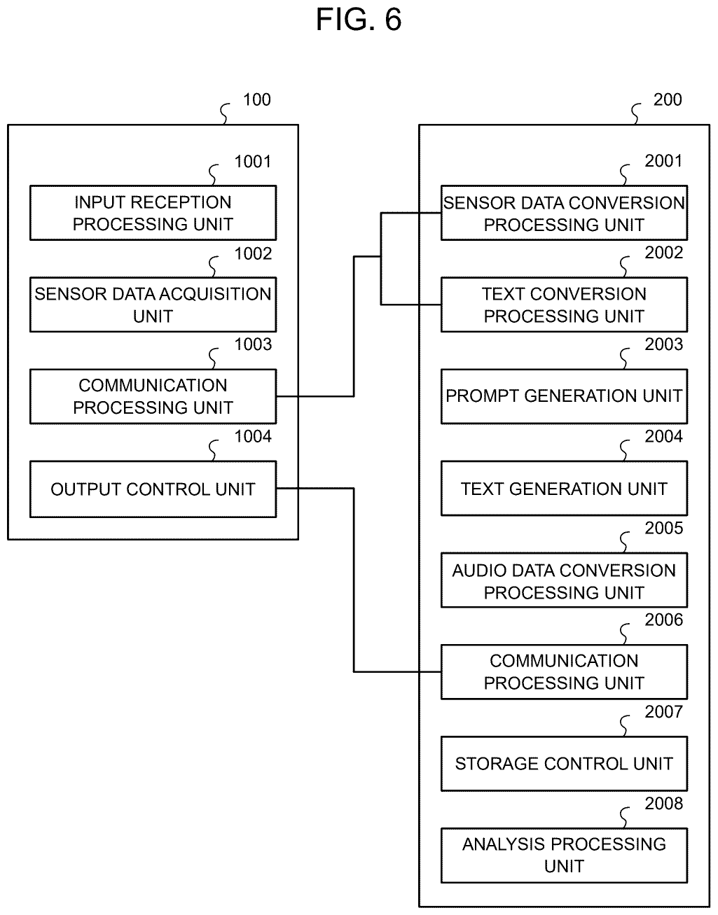

Next, functional configurations of the interface device 1 and the text generation device 2 will be described. FIG. 6 is a block diagram illustrating examples of functional configurations of the interface device 1 and the text generation device 2.

As illustrated in FIG. 6, the control unit 100 of the interface device 1 includes, as functional components, an input reception processing unit 1001, a sensor data acquisition unit 1002, a communication processing unit 1003, and an output control unit 1004.

Specifically, the control unit 100 (or the CPU 101) of the interface device 1 implements the above-described functional components by executing the control program 1041 stored in the memory unit 104. In the present embodiment, the above-described functional components are software components implemented by the cooperation between the processor and the control program 1041 of the interface device 1. However, the present disclosure is not limited to this example, and some or all of the functional components may be implemented by hardware components, such as dedicated circuits. Also, the functional configuration of the interface device 1 is not limited to this example.

The input reception processing unit 1001 outputs voice guidance when a user is detected. Specifically, when detecting, via the imaging unit 107, a user who uses the interface device 1, the input reception processing unit 1001 outputs voice guidance via the speaker 108. Here, the voice guidance is voice information that prompts the user to operate the interface device 1. For example, when the imaging unit 107 detects that the user has approached the interface device 1 installed on a sales floor, the input reception processing unit 1001 outputs voice guidance “Welcome. Are you looking for something?” via the speaker 108.

Any detection method may be used to detect the user. For example, the user may be detected via a sensor (for example, a human presence sensor) included in the sensor 111. Also, instead of outputting voice guidance, the input reception processing unit 1001 may output display guidance for the user on the display unit 105.

Also, the input reception processing unit 1001 receives an input of audio data (or voice data) from the user. Specifically, the input reception processing unit 1001 receives an input of audio data from the user via the microphone 109. For example, when the user utters a question (or an inquiry) “What do you recommend today?” in response to the voice guidance, the input reception processing unit 1001 receives audio data representing the question via the microphone 109.

Note that a question from a user is not necessarily received as audio data. As another example, the input reception processing unit 1001 may display an input field, in which text can be input by a touch operation, on the display unit 105 to enable the user to input a question via the operating unit 106.

The sensor data acquisition unit 1002 acquires sensor data from the sensor 111. Specifically, the sensor data acquisition unit 1002 acquires sensor data from the sensor 111 via the device interface 110. The sensor data acquisition unit 1002 may acquire sensor data from multiple sensors included in the sensor 111.

The communication processing unit 1003 transmits various types of data to the text generation device 2. Specifically, the communication processing unit 1003 transmits audio data received by the input reception processing unit 1001 and sensor data acquired by the sensor data acquisition unit 1002 to the text generation device 2.

The output control unit 1004 outputs audio data (or voice data) based on an answer generated by the text generation LLM 2043. Specifically, upon receiving audio data from the text generation device 2, the output control unit 1004 outputs the audio data via the speaker 108.

Note that, instead of receiving audio data and outputting the audio data via the speaker 108, the output control unit 1004 may receive an answer (or text) generated by the text generation LLM 2043 and display the answer on the display unit 105.

The control unit 200 of the text generation device 2 includes a sensor data conversion processing unit 2001, a text conversion processing unit 2002, a prompt generation unit 2003, a text generation unit 2004, an audio data conversion processing unit 2005, a communication processing unit 2006, a storage control unit 2007, and an analysis processing unit 2008 as functional components.

Specifically, the control unit 200 (or the CPU 201) of the text generation device 2 implements the above-described functional components by executing the control program 2041 stored in the memory unit 204. In the present embodiment, the above-described functional components are software components implemented by the cooperation between the processor and the control program 2041 of the text generation device 2. However, the present disclosure is not limited to this example, and some or all of the functional components may be implemented by hardware components, such as dedicated circuits. Also, the functional configuration of the text generation device 2 is not limited to this example.

The sensor data conversion processing unit 2001 of the text generation device 2 is an example of a first conversion unit. The sensor data conversion processing unit 2001 acquires sensor data transmitted from the interface device 1. Also, the sensor data conversion processing unit 2001 converts, based on the label dictionary 2042, the acquired sensor data into a label that qualitatively represents a state indicated by the acquired sensor data.

Specifically, when sensor data is received from the interface device 1, the sensor data conversion processing unit 2001 classifies the sensor data into one of the classes defined for the corresponding type of sensor data. For example, when a temperature measured by the temperature sensor is less than 15° C., the temperature is classified into a class “1”; when the temperature is greater than or equal to 15° C. and less than 25° C., the temperature is classified into a class “2”; and when the temperature is greater than or equal to 25° C., the temperature is classified into a class “3”. Then, the sensor data conversion processing unit 2001 refers to the label dictionary 2042 and acquires a label corresponding to one of the classes defined for the corresponding type of sensor data.

Note that the sensor data conversion processing unit 2001 may input sensor data to a trained model that is trained to classify the input sensor data into a class corresponding to the input sensor data and may acquire a classification result from the trained model. Also, the sensor data conversion processing unit 2001 may input sensor data to a trained model trained to determine a threshold for the sensor data, that is, a value serving as a boundary for classifying the sensor data, and may classify the sensor data based on the threshold determined by the trained model. Note that the labels registered in the label dictionary 2042 may also be output in advance by a trained model trained with data indicating the relationship between temperatures and the hotness and coldness felt by a human. Furthermore, the number of classes into which sensor data is classified is not limited to the above-described example.

The text conversion processing unit 2002 is an example of an acquisition unit and a second conversion unit. The text conversion processing unit 2002 acquires a query indicating a question input by the user. Specifically, the text conversion processing unit 2002 acquires audio data transmitted from the interface device 1, that is, audio data including a question from the user, and converts the audio data including the question into text.

The text conversion processing unit 2002 converts the audio data received from the interface device 1 into text that is used as a query describing the question from the user. Note that the conversion from the audio data to the query may be performed by using a trained model that uses a known voice recognition technique or by using an algorithm that is not based on machine learning.

The prompt generation unit 2003 is an example of a first generation unit. The prompt generation unit 2003 generates a prompt based on a label and a query indicating a question from the user.

Specifically, the prompt generation unit 2003 generates a prompt by combining a label converted from sensor data by the sensor data conversion processing unit 2001 and a query converted from audio data by the text conversion processing unit 2002.

For example, assume that the value of sensor data acquired from the temperature sensor is classified into the class “3” by the sensor data conversion processing unit 2001. In the label dictionary 2042 illustrated in FIG. 4, the label associated with the class “3” of the temperature is “warm”. Also, assume that the combination of the value of sensor data acquired from the temperature sensor and the value of sensor data acquired from the humidity sensor is classified into the class “3” by the sensor data conversion processing unit 2001. In the label dictionary 2042 illustrated in FIG. 4, the label associated with the class “3” of the combination of the temperature and humidity is “comfortable weather”.

In the above case, the prompt generation unit 2003 combines the labels corresponding to the classes determined by the sensor data conversion processing unit 2001 with the query and thereby generates, for example, a prompt “The weather is warm and comfortable today. What do you recommend today?” By generating a prompt incorporating one or more labels corresponding to sensor data as described above, it is expected that an answer suitable for the present situation of the user can be obtained from the text generation LLM 2043.

In other words, the prompt generation unit 2003 converts sensor data, which is numerical data, into a label, which is text data including a qualitative expression, and then incorporates the label into a prompt. This is because LLM is generally not good at handling numerical values, such as sensor measurements, and it is difficult to obtain an answer appropriately reflecting the meaning indicated by sensor data by directly incorporating the numerical value of the sensor data into a prompt.

The text generation unit 2004 is an example of a second generation unit. The text generation unit 2004 generates text including an answer to a query by inputting a prompt generated by the prompt generation unit 2003 to the text generation LLM 2043.

For example, the text generation unit 2004 inputs a prompt “The weather is warm and comfortable today. What do you recommend today?” The text generation LLM 2043 receives the input of the prompt and outputs an answer, such as “How about a cool and delicious ice cream?”, reflecting the environment represented by the label (or labels) included in the input prompt.

In the above-described example, the answer of the text generation LLM 2043 does not simply indicate a “recommended item” but indicates a “recommended item” that suits the environmental condition represented by the labels “warm” and “comfortable weather”. Note that the answer described above is merely an example, and the content and the wording of an answer are not limited to the above example.

The audio data conversion processing unit 2005 is an example of a third conversion unit. The audio data conversion processing unit 2005 converts text including an answer to a query generated by the text generation unit 2004 into audio data.

The communication processing unit 2006 is an example of a providing unit. The communication processing unit 2006 transmits audio data converted from an answer by the audio data conversion processing unit 2005 to the interface device 1.

The storage control unit 2007 stores, in a storage device (e.g., the memory unit 204), data (or question record data) in which a query, an answer, and sensor data and/or a label are associated with each other. Specifically, the storage control unit 2007 stores the question record data in the question record DB 2044.

More specifically, each time a pair of audio data and sensor data is received from the interface device 1, the storage control unit 2007 stores a query generated from the audio data, an answer to a prompt generated based on the query, a value of the sensor data, a class, and a label in association with each other.

When the user who has received audio data, which includes an answer and is transmitted to the interface device 1, utters a question (hereinafter, also referred to as an additional question) regarding the received audio data, the storage control unit 2007 may request the text conversion processing unit 2002 to convert audio data including the additional question into text and store the text in the question record DB 2044 in association with the question record data corresponding to the answer.

In addition, when the user repeatedly asks additional questions, the storage control unit 2007 may assign a common identifier to the series of additional questions and store text representing the additional questions in the question record DB 2044 in association with the common identifier so that it can be identified that the additional questions belong to the same user.

The analysis processing unit 2008 performs statistical analysis on the basis of various types of data stored in the question record DB 2044. Specifically, the analysis processing unit 2008 uses a known statistical analysis technique to statistically analyze the accuracy and validity of answers generated by the text generation LLM 2043 based on the question record data stored in the question record DB 2044.

Also, the analysis processing unit 2008 may perform various types of analysis processing, such as statistical analysis, based on, for example, a database storing product sales results in addition to the question record DB 2044. Furthermore, targets and methods of analysis performed by the analysis processing unit 2008 may be changed for each store that manages the question record DB 2044.

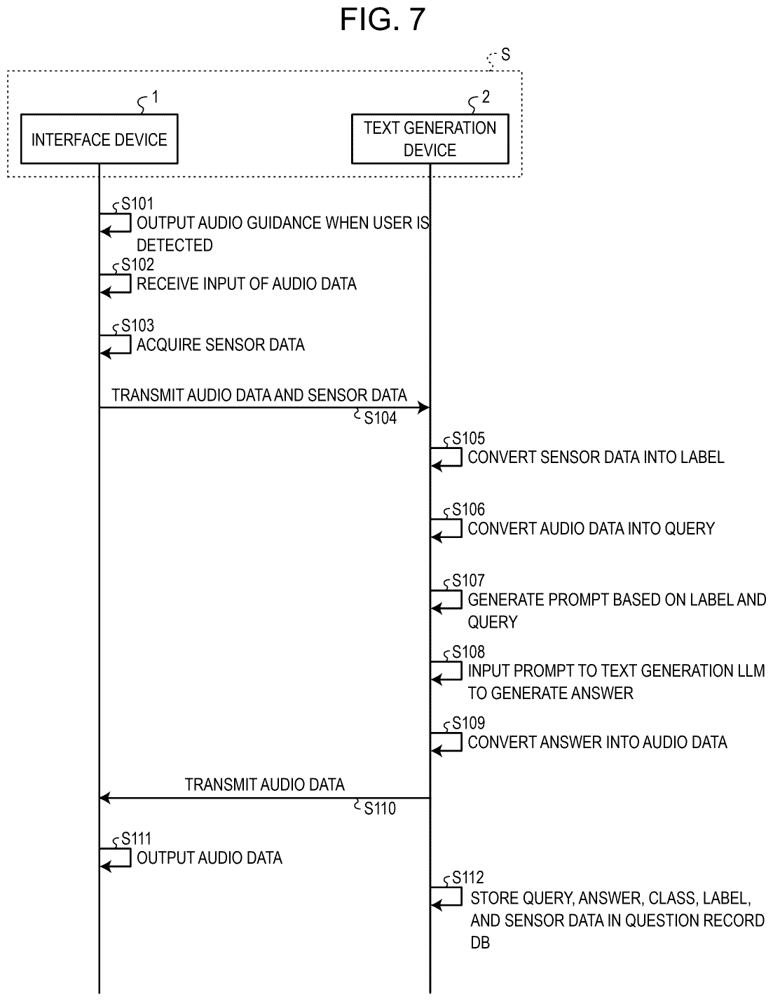

Next, a control process performed in the concierge system S will be described with reference to FIG. 7.

FIG. 7 is a sequence diagram illustrating an example of a control process performed by the concierge system S. In the sequence diagram illustrated in FIG. 7, after the text generation device 2 receives sensor data and audio data transmitted from the interface device 1, a prompt, which is generated based on a label converted from the sensor data and a query converted from the audio data, is input to the text generation LLM 2043; an answer generated by the text generation LLM 2043 is acquired; and audio data converted from the acquired answer is transmitted to the interface device 1. The CPU 101 (or the processor) of the interface device 1 is configured to execute the control program 1041 stored in the memory unit 104 to perform the corresponding steps in FIG. 7. Also, the CPU 201 (or the processor) of the text generation device 2 is configured to execute the control program 2041 stored in the memory unit 204 to perform the corresponding steps in FIG. 7.

First, when a user who uses the interface device 1 is detected via the imaging unit 107, the input reception processing unit 1001 of the interface device 1 outputs audio guidance via the speaker 108 (step S101). Next, the input reception processing unit 1001 receives an input of audio data from the user via the microphone 109 (step S102).

Next, the sensor data acquisition unit 1002 of the interface device 1 acquires sensor data from the sensor 111 via the device interface 110 (step S103). Next, the communication processing unit 1003 of the interface device 1 transmits the audio data received by the input reception processing unit 1001 and the sensor data acquired by the sensor data acquisition unit 1002 to the text generation device 2 (step S104).

In the text generation device 2, when the audio data and the sensor data are received from the interface device 1, the sensor data conversion processing unit 2001 classifies the sensor data into one of the classes defined for the corresponding type of sensor data. Next, the sensor data conversion processing unit 2001 refers to the label dictionary 2042 and acquires a label corresponding to the class into which the sensor data is classified (step S105). Thus, the sensor data conversion processing unit 2001 converts the sensor data into a label.

The text conversion processing unit 2002 of the text generation device 2 converts the audio data including a question and received from the interface device 1 into text (or a query) (step S106). Next, the prompt generation unit 2003 of the text generation device 2 generates a prompt by combining the label converted from the sensor data by the sensor data conversion processing unit 2001 with the query converted from the audio data by the text conversion processing unit 2002 (step S107).

Subsequently, the text generation unit 2004 of the text generation device 2 generates an answer (or text including an answer) to the query by inputting the prompt generated by the prompt generation unit 2003 to the text generation LLM 2043 (step S108). Next, the audio data conversion processing unit 2005 of the text generation device 2 converts the answer generated by the text generation unit 2004 into audio data (step S109). Then, the communication processing unit 2006 of the text generation device 2 transmits the audio data obtained by the audio data conversion processing unit 2005 to the interface device 1 (step S110).

When the audio data is received from the text generation device 2, the output control unit 1004 of the interface device 1 outputs the audio data via the speaker 108 (step S111).

On the other hand, the storage control unit 2007 of the text generation device 2 stores the answer generated at step S108, the class of the sensor data transmitted from the interface device 1, the label corresponding to the class, and the value of the sensor data in the question record DB 2044 in association with the query acquired at step S106 (step S112).

As described above, according to the text generation device 2 of the present embodiment, audio data including a question of the user is converted into a query, and a prompt, which is generated based on the query and a label corresponding to sensor data related to the environment around the user (or the store), is input to the text generation LLM 2043 to acquire an answer from the text generation LLM 2043. This makes it possible to obtain an answer reflecting environmental information, which is based on sensor data obtained from the sensor 111, in response to a query. That is, the above configuration makes it possible to reflect, in an answer to a question from a user, information regarding an environment or a condition that is present when the user uses the interface device 1.

Also, according to the text generation device 2 of the present embodiment, an answer, a class of sensor data of the sensor 111, a label corresponding to the class, and the value of the sensor data are stored in the question record DB 2044 in association with a query. This makes it possible to accumulate data as users use the concierge system S, and the accumulated data can be used, for example, to analyze trends in user interest and what kinds of information users want under what kinds of environments.

The above-described embodiment can be modified as appropriate by changing parts of the configuration or functions of each of the above-described devices (the interface device 1 and the text generation device 2). Therefore, variations of the above-described embodiment will be described below as other embodiments. Note that differences from the above-described embodiment will be mainly described below, and detailed descriptions of the same features as those described above will be omitted. Also, variations described below may be implemented individually or in combination as appropriate.

### First Variation

In the above-described embodiment, the label dictionary 2042 stores data for converting a quantitative measurement value indicated by sensor data into a qualitative value.

Alternatively, the label dictionary 2042 may store data for classifying features represented by a captured image (hereinafter, also referred to as an image) of a user into predetermined user attributes. For example, the label dictionary 2042 may store estimated ages and sex of users as labels.

In this case, when acquiring sensor data from the sensor 111, the sensor data acquisition unit 1002 of the interface device 1 also acquires an image for identifying the characteristics, such as the face and clothes, of the user via the imaging unit 107.

Then, the communication processing unit 1003 of the interface device 1 transmits the image as a part of sensor data to the text generation device 2. Also, the sensor data conversion processing unit 2001 of the text generation device 2 extracts the characteristics of the user from the received image by using a known image processing technique or image recognition technique and thereby extracts information representing user attributes, such as the sex and the age of the user. Then, the sensor data conversion processing unit 2001 refers to the label dictionary 2042 and converts the extracted user attributes into labels (hereinafter also referred to as characteristic label).

This makes it possible to generate a prompt reflecting the attributes of the user using the concierge system S and thereby makes it possible to obtain an answer reflecting the attributes of the user. The text generation device 2 may be configured to generate a prompt based on a query and a characteristic label indicating a characteristic of the user or based on a query, a label indicating a surrounding environment of the user, and a characteristic label indicating a characteristic of the user.

### Second Variation

In the above-described embodiment, it is assumed that each query stored in the question record DB 2044 is obtained by converting audio data including a question from the user into text by the text conversion processing unit 2002. However, the present disclosure is not limited to this example, and each query stored in the question record DB 2044 may be a prompt that includes text converted from audio data and a label.

Programs executed in the concierge system S according to the present embodiment and the variations may be stored in a computer connected to a network, such as the Internet, and may be downloaded via the network. Also, programs executed in the concierge system S according to the present embodiment and the variations may be provided or distributed via a network, such as the Internet.

Programs executed by the devices (the interface device 1 and the text generation device 2) of the above-described embodiments may be provided in advance in a ROM, a storage unit, or the like of each of the devices. The programs executed by the devices of the above-described embodiments may be provided in a non-transitory computer-readable storage medium, such as a CD-ROM, a flexible disk (FD), a CD-R, or a Digital Versatile Disk (DVD) in an installable format or an executable format.

While certain embodiments have been described, these embodiments have been presented by way of example only and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A shopping terminal that is used in a store, comprising:
a memory that stores labels indicating environmental conditions each in association with sensor data; and
a processor configured to execute a program that is stored in the memory to perform the steps of:
acquiring a query indicating a question input by a user,
acquiring sensor data from a sensor,
searching the memory for a label corresponding to the acquired sensor data,
generating a prompt based on the query and the label,
inputting the prompt to a computer model, which generates in response thereto an answer to the question, wherein the computer model has learned relationships and connections between human perceptions under different environmental conditions, and data of items sold in the store, and
converting the answer into audio data, and outputting the audio data.

2. The shopping terminal according to claim 1, wherein
the steps further include converting audio data uttered by the user and including the question into text, and
the text is acquired as the query.

3. The shopping terminal according to claim 1, further comprising:
a communication interface, wherein
the audio data is transmitted to a device being used by the user via the communication interface.

4. The shopping terminal according to claim 1, wherein
the steps further include:
extracting a characteristic of the user from an image, and
converting the characteristic of the user into a characteristic label that qualitatively expresses the characteristic of the user, and
the prompt is generated based on the query, the label, and the characteristic label.

5. The shopping terminal according to claim 1, wherein
the labels are associated with classes defined for each type of sensor data, and
the steps further include classifying the sensor data.

6. The shopping terminal according to claim 5, wherein
a total number of classes varies depending on types of sensor data.

7. The shopping terminal according to claim 1, wherein
the computer model is a large language model.

8. The shopping terminal according to claim 1, wherein
the steps further include performing statistical analysis based on the answer.

9. The shopping terminal according to claim 1, wherein
the sensor data includes at least one of a temperature and humidity.

10. The shopping terminal according to claim 1, wherein
the computer model is fine-tuned to change the answer or wording of the answer according to an application of the shopping terminal.

11. A method performed by a shopping terminal, the method comprising:
storing, in a memory, labels indicating environmental conditions each in association with sensor data;
acquiring a query indicating a question input by a user;
acquiring sensor data from a sensor;
searching the memory for a label corresponding to the acquired sensor data;
generating a prompt based on the query and the label;
inputting the prompt to a computer model, which generates in response thereto an answer to the question, wherein the computer model has learned relationships and connections between human perceptions under different environmental conditions, and data of items sold in the store; and
converting the answer into audio data, and outputting the audio data.

12. The method according to claim 11, further comprising:
converting audio data uttered by the user and including the question into text, wherein
the text is acquired as the query.

13. The method according to claim 11, wherein
the audio data is output to a device being used by the user.

14. The method according to claim 11, further comprising:
extracting a characteristic of the user from an image; and
converting the characteristic of the user into a characteristic label that qualitatively expresses the characteristic of the user, wherein
the prompt is generated based on the query, the label, and the characteristic label.

15. The method according to claim 11, wherein
the labels are associated with classes defined for each type of sensor data, and
the method further comprises classifying the sensor data.

16. The method according to claim 15, further comprising:
a total number of classes varies depending on types of sensor data.

17. The method according to claim 11, wherein
the computer model is a large language model.

18. The method according to claim 11, further comprising:
performing statistical analysis based on the data stored in the memory.

19. The method according to claim 11, wherein
the sensor data includes at least one of a temperature and humidity.

20. A shopping system comprising:
an interface terminal; and
an information processing device, wherein
the interface terminal is configured to
receive an input of audio data including a question from a user,
acquire sensor data from a sensor, and
transmit the audio data and the sensor data to the information processing device,
the information processing device includes a memory stores labels indicating environmental conditions each in association with sensor data, and
the information processing device is configured to
receive the audio data and the sensor data from the interface terminal,
convert the audio data into a query indicating the question,
searching the memory for a label corresponding to the acquired sensor data,
generate a prompt based on the query and the label,
input the prompt to a computer model, which generates in response thereto an answer to the question, wherein the computer model has learned relationships and connections between human perceptions under different environmental conditions, and data of items sold in the store, and
convert the answer into audio data, and transmitting the audio data to the interface terminal.
